(19) United States
(12) Patent Application Publication
(10) Pub. No.: US 2005/0182160 A1
(43) Pub. Date: Aug. 18, 2005

(54) Polymer Modified Bricks

(75) Inventors: Fereydoon Milani Nejad, Laguna Niguel, CA (US); Nima Milani Nejad, Laguna Niguel, CA (US)

Correspondence Address: NIMA MILANI NEJAD, 4 BELLE ISLE DR., LAGUNA NIGUEL, CA, 97677, US

(73) Assignee: Dr. Fereydoon Milani Nejad, Laguna Niguel, CA (US)

(21) Appl. No.: 10/907,679

(22) Filed: Apr. 12, 2005

(51) Int. Cl. C08K 3/00

(52) U.S. Cl. 523/343; 428/903.3

(57) ABSTRACT

We have developed new composites from crumb rubber and fiber. The crumb rubber manufactured from used tires and fiber or fluff a portion of the waste obtained from tire threads (nylon or polyester) in recycling of used tires is embedded into a matrix of clay to produce a light weight brick with enhanced heat and sound insulation properties. These properties make the composite a suitable candidate for dividing walls and sound barriers, roof shingles, etc. The material could be cut into desired shape with smooth surface. The brick like texture, color, light weight and smooth surface make the composite a suitable candidate for outside walls and decor. In addition, the production of this composite can be considered as a new outlet for recycled used tires.

### BACKGROUND OF THE INVENTION

This invention relates to the production of Composite compounds from two products obtained from recycling used tires; that are a composite from crumb rubber and a composite from fiber (nylon and or polyester). Crumb rubber is produced by stepwise grinding of used tires and fiber is by product in crumb rubber production. The crumb rubber is being used in different industries such as rubberize asphalt, mats production, play ground athletic fields, etc. Production of crumb composite will open up a new market for crumb rubber and production of fiber composite will divert a waste stream from landfill to a useful material thus reduce the environmental pollution associated with used tires and land filling the fiber. In addition, as described below, these new composites have wide variety of applications due to their unique properties.

### BRIEF SUMMARY OF THE INVENTION

We have successfully produced new composites; that is a composite mainly from clay and crumb rubber and clay and another composite from waste fiber and clay. These new composites are very light weight, with compatible physical strength to plywood and excellent heat and sound insulation properties. Due to these characteristics and properties, these new composites can have variety of applications in the construction industry.

### DETAILED DESCRIPTION OF THE INVENTION

Polymer Modified Bricks are new composite materials manufactured mainly from clay and scrap polymers obtained from recycling used tires. In this patent application, two type of scrap polymers are described for the production of polymer modified bricks: 1) crumb rubber and 2) fiber (scrap nylon and polyester).

Crumb rubber is a granulated rubber obtained from used tires. Crumb rubber itself is a main component of this new composite. The production of this new composite will provide a new outlet for the recycling of used tires, therefore reducing the amount of used tires that need to be land filled and helping to reduce environmental pollution.

In addition, the thread in tires physically is converted to fluff (fiber). At present fiber is considered a waste material and is land filled. This waste contains rubber and it could be used directly in composite production. But a better quality composite is produced if the fiber waste is reprocessed to remove crumb rubber and use the fine fiber in composite production. The re-claimed crumb rubber could be used in production of rubber-clay composite or for other applications.

These composites are very light weight with a density of 1.16-1.30 g/ml and have physical strength computable to plywood. In addition, they have excellent sound and heat insulation properties. The polymer either as rubber or fiber is imbedded in a matrix of clay; the clay acts as a fire retardant. In addition, these composites can be cut and molded into any desired shape. Due to these unique properties, we believe that these composites can have a wide variety of applications in the construction industry.

Components for fiber-clay composite: Clay, waste fiber, water, Colorant if desired for production Material ratio: Clay/waste fiber≅(65-70)/(35-30); Water/(clay, fiber)≅1/1

The texture of the produced from fiber will vary with extent of fiber contamination with crumb rubber and fines of fluff. The fine fluff with less rubber contamination will produce a soft surface.

Components of clay-rubber composite: Clay, crumb rubber, water, Colorant if desired.

Material ratio: Clay/crumb rubber≅60/40; Water/(sum of clay, crumb rubber)≅1/1

The texture will depend on the fines of crumb rubber used, Fine crumb rubber produces finer surface.

Procedure: Mix clay with water in a mixer, until a uniform sludge is obtained. Uniformity and quality of final product is dependent on the fines of waste fiber or crumb rubber. Gradually add fiber or rubber to the mix until a uniform paste is obtained. Add the colorant if desired. Transfer the material into a mold with the desired shape or preferably to a large container (for example a 1 cubic meter wooden box), use a vibrator rod to remove the trapped air. After the air bubbling is ceased, the mold is transfer to heat chamber with the temperature at 50° C. for 30 minutes. Then the composite is removed from the mold and the composite is transferred to a heat chamber with the temperature at 180-200° C. with proper hood and filters. The temperature curing lasts between 30 to 90 minutes depending on the mass of the composite.

After cooling to room temperature, the composite could be cut to the desired shape and size.

Definition List 1

| Term | Definition |
|---|---|
| Crumb rubber | Granulated rubber usually obtained from |
| | used tires |
| Fiber/fluff | The thread (nylon or polyester) in used |
| | tire is converted to a fluffy material |
| | called fiber or fluff |
| Clay | Soil that is plastic and tenacious when |
| | moist and that becomes permanently |
| | hard when baked or fired |

1. The invention of new composites which are mainly composed of recycled crumb rubber and fiber.

2. The composites in claim 1 are very light with a density of 1.16-1.30 g/ml.

3. The composites in claim 1 have enhanced heat insulation properties.

4. The composites in claim 1 have enhanced sound insulation properties.

5. The composites in claim 1 have physical strength that is comparable to wood and plywood.

6. The composites in claim 1 are fire retardant.

7. Due to its unique properties, the composites in claim 1 have wide variety of applications including production of light weight bricks, dividing walls, sound barriers and roof shingles.

8. The composites in claim 1 can be colored during the production process.

9. During the production process of the composites in claim 1, are cured at 180-200° C.

10. The composites in claim 1 can be cut and molded into unique shapes.

11. The composites in claim 1 can be colored with coloring agent.

12. The components for fiber-clay composite in claim 1 are Clay, waste fiber and water.

13. The Components of clay-rubber composite in claim 1 are Clay, crumb rubber and water.

14. The composite in claim 1 is initially produced by mixing clay and water, and then fiber or rubber is added.
